(19) United States
(12) Patent Application Publication
(10) Pub. No.: US 2012/0177055 A1
(43) Pub. Date: Jul. 12, 2012

(54) SWITCH DEVICE, NETWORK, AND ADDRESS LEARNING METHOD USED FOR THEM

(75) Inventor: Yoshiharu KOBATAKE, Tokyo (JP)

(73) Assignee: NEC CORPORATION, Tokyo (JP)

(21) Appl. No.: 13/344,287

(22) Filed: Jan. 5, 2012

(30) Foreign Application Priority Data
Jan. 12, 2011 (JP) 2011-003526

(51) Int. Cl. H04L 12/56

(52) U.S. Cl. 370/401; 370/400

(57) ABSTRACT

A switch device capable of achieving a significant load reducing effect without placing any load on the MAC address learning function is provided. A switch device (1) is used in a network in which MAC addresses to be used are limited within a closed network. The switch device (1) includes a determination unit (E-OAM frame determination function unit 12) that determines whether a received frame is an Ether-OAM frame or not, and a MAC address learning unit (MAC address learning function unit 14) that, when the received frame is determined to be an Ether-OAM frame in the determination unit, regards that Ether-OAM frame as an object to be learned and thereby learns a MAC address.

### INCORPORATION BY REFERENCE

This application is based upon and claims the benefit of priority from Japanese patent application No. 2011-003526, filed on Jan. 12, 2011, the disclosure of which is incorporated herein in its entirety by reference.

### BACKGROUND OF THE INVENTION

1. Technical Field

The present invention relates to a switch device, a network, and an address learning method used for them. In particular, the present invention relates to an address learning method in a closed network such as a provider backbone bridge network.

2. Background Art

In recent years, wide area Ethernet™ services in which networks located in separated places are connected through PBNs (Provider Backbone Networks) have become widespread.

In these wide area Ethernet™ services, all the switches within the PBN need to learn an enormous number of MAC (Media Access Control) addresses including client MAC addresses used within clients (for example, see International Patent Publication No. WO 2006/093321 (hereinafter called “Patent literature 1”)). Further, the load on FDBs (Forwarding Data Bases) has been increasing as the communication capacity of the PBN has increased because of the spread of the Internet.

Accordingly, a method for concealing MAC addresses within clients by adding different Ether headers in Ether frames, to which the present invention relates, (e.g., PBB (Provider Backbone Bridge)) has been proposed. This method can reduce the load on the MAC learning table of PBBNs (Provider Backbone Bridge Networks).

However, the FDB load tends to increase in the future due to the increase of the communication capacity. Further, in the PBNs and PBBNs, the introduction of Ether-OAM (Operations, Administration and Maintenance) is becoming more common in order to compensate for the poor reliability of Ethernet™.

In recent years, the communication capacity has increased (10 Gbps, 40 Gbps, 100 Gbps, and so on), and chassis-type L2 (layer 2) switches capable of coping with these large capacities have been introduced. In these chassis-type L2 switches, when the MAC address learning function is distributed over a plurality of devices, it is necessary to synchronize the learning contents among the plurality of devices.

In the chassis-type L2 switch in which the MAC address learning function is distributed over a plurality of devices, a method in which when a frame for which learning is necessary is received, the device that has received that frame notifies other devices so that the other devices also perform learning is often used. However, this method is often implemented by software, thus causing a problem that the learning performance is significantly poor compared to the transfer performance of high-speed interfaces such as 10 Gbps, 40 Gbps, 100 Gbps, and so on.

Further, in the L2 switch, the MAC address learning is usually performed for every received frame. Therefore, although only the first frame is required for the learning process under normal circumstances, there are many cases in which a frame of the same kind is received for a plurality of times in actual networks. As a result, unnecessary learning notifications are sent to other devices, thus deteriorating the learning performance even further.

In high-speed interfaces, the number of frames that are received after the first frame has arrived and before the learning process has completed is large. Therefore, the higher the interface is, the worse the problem becomes. This problem become more obvious, for example, when all the MAC addresses are deleted due to the route change or the like in ring networks.

Therefore, in the L2 switch, frame flooding occurs during the period before the re-learning, thus making it impossible to perform band distribution in link aggregation or the like and thereby causing a problem that the network cannot be operated with efficiency.

Further, in the L2 switch, it is necessary to improve the MAC address learning function performance. However, to improve the MAC address learning performance, it is necessary to speed up a plurality of devices (CPU (Central Processing Unit), memory, etc.) relevant to the MAC address learning, thus causing problems in terms of the costs and technical aspects. It should be noted that the above-mentioned problems also occur in the method disclosed in the above-mentioned Patent literature 1.

### SUMMARY

Accordingly, an exemplary object of the invention is to solve the above-described problems and to provide a switch device, a network, and an address learning method used for them, capable of achieving a significant load reducing effect without placing an additional load on the MAC address learning function.

In a first exemplary aspect of the invention, a switch device used in a network in which a MAC (Media Access Control) address to be used is limited within a closed network, includes: a determination unit that determines whether a received frame is an Ether-OAM (Operations, Administration and Maintenance) frame or not; and a MAC address learning unit that, when the received frame is determined to be an Ether-OAM frame in the determination unit, regards that Ether-OAM frame as an object to be learned and thereby learns a MAC address.

A second exemplary aspect of the invention is a network in which a MAC (Media Access Control) address to be used is limited within a closed network, in which a switch device includes: a determination unit that determines whether a received frame is an Ether-OAM (Operations, Administration and Maintenance) frame or not; and a MAC address learning unit that, when the received frame is determined to be an Ether-OAM frame in the determination unit, regards that Ether-OAM frame as an object to be learned and thereby learns a MAC address.

A third exemplary aspect of the invention is an address learning method used in a network in which a MAC (Media Access Control) address to be used is limited within a closed network, in which a switch device executes: a determination process of determining whether a received frame is an Ether-OAM (Operations, Administration and Maintenance) frame or not; and when the received frame is determined to be an Ether-OAM frame in the determination process, a MAC address learning process of regarding that Ether-OAM frame as an object to be learned and thereby learning a MAC address.

The present invention can achieve an advantageous effect that a significant load reducing effect can be achieved without placing an additional load on the MAC address learning function by using the above-described configuration and operation.

### BRIEF DESCRIPTION OF THE DRAWINGS

The above and other aspects, features, and advantages of the present invention will become more apparent from the following description of certain exemplary embodiments when taken in conjunction with the accompanying drawings, in which:

FIG. 1 is a block diagram showing a configuration example of a switch device according to an exemplary embodiment of the present invention;

FIG. 2 is a block diagram showing a configuration example of a network according to an exemplary embodiment of the present invention; and

FIG. 3 is a flowchart showing a common operation of a backbone switch and edge switches shown in FIG. 2.

### EXEMPLARY EMBODIMENTS

### First Exemplary Embodiment

Next, exemplary embodiments according to the present invention are explained with reference to the drawings. Firstly, an outline of a network according to an aspect of the present invention is explained. A network according to the present invention relates to a network in which MAC (Media Access Control) addresses to be used are limited in a closed network such as a PBBN (Provider Backbone Bridge Network) (IEEE 802.1ah).

According to an aspect of the present invention, the load of MAC address learning is reduced by using only an Ether-OAM (Operations, Administration and Maintenance) (IEEE 802.1ag, ITU-T y.1731) frame(s) as the object to be learned when the Ether-OAM frame is transmitted/received from one edge switch to another edge switch within this network. User frames that are transferred between client apparatuses are transferred by using a learning result obtained by using the Ether-OAM frame. In this way, it is possible to eliminate the user frames from the frames for which MAC addresses need to be learned. Further, in addition to the user frames, control frames and the like except for the Ether-OAM frame may be also included in the frames that can be eliminated from the frames for which the learning needs to be performed. That is, the frames that can be eliminated from the frames for which the learning needs to be performed may be all the frames other than the Ether-OAM frame.

FIG. 1 is a block diagram showing a configuration example of a switch device according to an exemplary embodiment of the present invention. In particular, FIG. 1 shows a configuration example of a backbone switch or an edge switch used in a PBBN.

In FIG. 1, a switch device 1 includes a frame input interface 11, an E-OAM (Ether-OAM) frame determination function unit 12, a frame output interface 13, and a MAC address learning function unit 14. The frame input interface 11 receives a frame from an input port or the like (not shown) and outputs the frame to the E-OAM frame determination function unit 12. Further, the frame output interface 13 outputs a frame that is received from the E-OAM frame determination function unit 12 to an output port or the like (not shown).

The E-OAM frame determination function unit 12 receives a frame from the frame input interface 11 and determines whether the received frame is an E-OAM frame or not. When the received frame is an E-OAM frame, the E-OAM frame determination function unit 12 instructs the MAC address learning function unit 14 to perform a learning process and transmits the received frame to the frame output interface 13.

The MAC address learning function unit 14 learns the source MAC address of the received frame in response to the notification from the E-OAM frame determination function unit 12 (when the received frame is determined to be an E-OAM frame).

Note that a part of a frame from which a MAC address can be learned is transferred from the E-OAM frame determination function unit 12 to the MAC address learning function unit 14, and the source MAC address of the received frame is learned in the MAC address learning function unit 14. In general, a learning result of the MAC address learning function unit 14 is expressed in a table format consisting of MAC addresses and port numbers of edge switches.

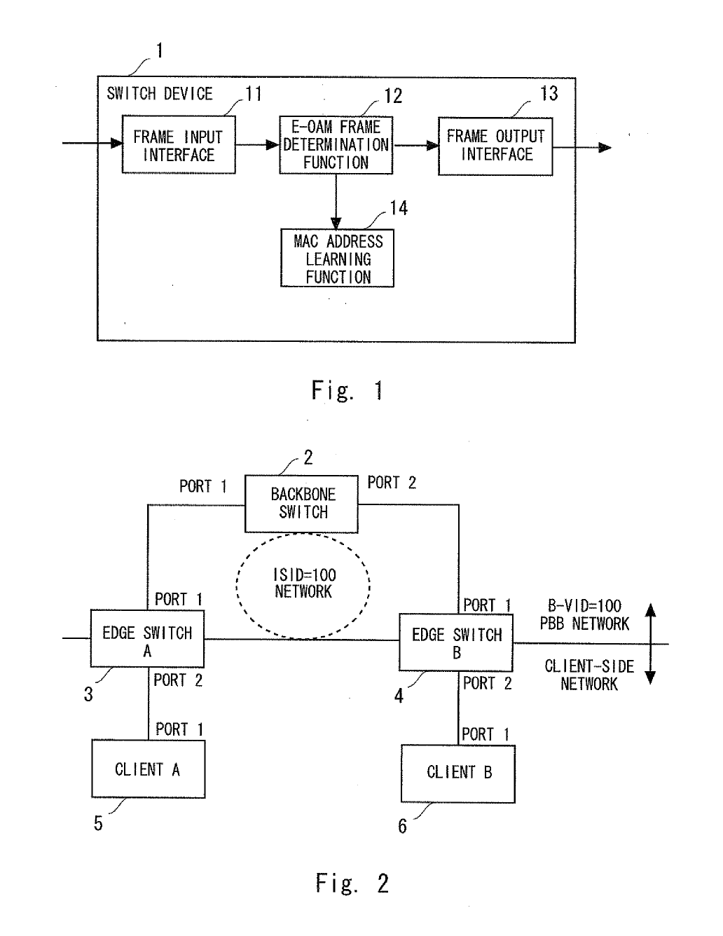

FIG. 2 is a block diagram showing a configuration example of a network according to an exemplary embodiment of the present invention. In particular, FIG. 2 shows a network configuration of a PBB (Provider Backbone Bridge). Note that the configuration of each of the backbone switch 2 and edge switches (A and B) 3 and 4 is similar to the configuration of the switch device 1 shown in FIG. 1.

In this network configuration, the backbone switch 2 and the edge switches (A and B) 3 and 4 belong to a network of Backbone-VID (Virtual Local Area Network IDentifier)=100.

Further, in this network configuration, the backbone switch 2 and the edge switches (A and B) 3 and 4 belong to a network of ISID (I-Service Instance Identifier)=1000.

Through this PBB network, a client (A) 5 and a client (B) 6 communicate with each other. Further, an ETH-CC [Ethernet(™) Continuity Check] is bidirectionally transmitted/received between the edge switch (A) 3 and the edge switch (B) 4. The ETH-CC is included in the E-OAM frame. Note that instead of the ETH-CC, a frame different from the ETH-CC included in the E-OAM frame may be transmitted/received between the edge switch (A) 3 and the edge switch (B) 4.

Although specific values are used for Backbone-VID and ISID in this exemplary embodiment, these values do not necessarily have to be used. Further, although the ETH-CC is exchanged between the edge switch (A) 3 and the edge switch (B) 4 in this exemplary embodiment, it may be exchanged between the client (A) 5 and the client (B) 6. That is, the only requirement in this exemplary embodiment is that the ETH-CC is transmitted between an inlet edge switch and an outlet edge switch within a PBB network.

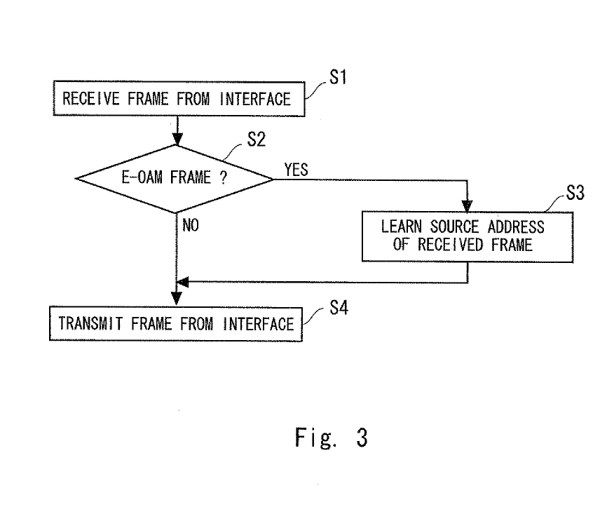

FIG. 3 is a flowchart showing a common operation of the backbone switch 2 and the edge switches (A and B) 3 and 4 shown in FIG. 2. In particular, FIG. 3 shows a common operation performed when the backbone switch 2 or the edge switch (A or B) 3 or 4 receives a frame.

When the backbone switch 2 receives a frame (step S1 in FIG. 3), the backbone switch 2 checks the Ether Type of the received frame and thereby determines whether the received frame is an E-OAM frame or not (step S2 in FIG. 3). The Ether Type is specified (0x8902) in ITU-T y.1731, IEEE 802.1ag.

When the backbone switch 2 determines that the received frame is an E-OAM frame, the backbone switch 2 urges the MAC address learning function unit 14 to learn the Backbone-source MAC address of the received frame (step S3 in FIG. 3). The Backbone-source MAC address is, for example, the MAC address of an edge switch used for a frame transfer within a network of Backbone-VID=100 or ISID=1000.

When the learning performed by the MAC address learning function unit 14 is finished, the backbone switch 2 transmits that frame through the frame output interface 13 (step S4 in FIG. 3).

Further, when the backbone switch 2 determines that the received frame is not an E-OAM frame, the backbone switch 2 transmits that frame through the frame output interface 13 without performing any process for the frame (step S4 in FIG. 3). In this process, the frame that is determined not to be an E-OAM frame is transferred to an edge switch or the like through an output port that is specified by using a MAC address learning result learned by using an E-OAM frame. When there is no MAC address learning result learned by using an E-OAM frame, the frame that is determined not to be an E-OAM frame may be transferred to an edge switch through a plurality of output ports of the backbone switch.

Next, an ETH-CC in a direction from the edge switch (A) 3 to the edge switch (B) 4 is explained.

Firstly, an ETH-CC frame whose Backbone-source MAC address is the address of the edge switch (A) 3 is transmitted from the edge switch (A) 3. This operation is similar to that of the ETH-CC in the L2 switch described above, to which the present invention relates.

Next, the operation is explained while focusing attention on the backbone switch 2 that has received this ETH-CC frame. Since the received frame is an ETH-CC, the backbone switch 2 performs learning and transmits it through the Port 2. As for the edge switch (B) 4, similarly to the backbone switch 2, since the received frame is an ETH-CC, the edge switch (B) 4 performs learning and processes the frame in the same manner as that in the L2 switch described above, to which the present invention relates.

Likewise, in the reversed direction from the edge switch (B) 4 to the edge switch (A) 3, learning is performed and is completed in a similar manner to that for the ETC-CC in the direction from the edge switch (A) 3 to the edge switch (B) 4.

Next, a user frame that flows in a network is explained. When a user frame is transmitted from the client (A) 5 before the ETH-CC is transmitted, the edge switch (A) 3 transmits the user frame in an un-learned state. Therefore, the edge switch (A) 3 transmits a Backbone-destination MAC address as a multicast using a Backbone Service Instance Group address OUI (OUI). This operation is an ordinary PBB operation. When a user frame is transmitted from the client (A) 5 after the ETH-CC is transmitted, the edge switch (A) 3 determines the port through which the user frame is received by using the MAC address learning result learned by using the ETH-CC.

The backbone switch 2 that has received this frame determines whether the received frame is an E-OAM frame or not (step S2 in FIG. 3). Then, since the received frame is a user frame, the received frame is transmitted through the Port 2 without performing the learning process. The edge switch (B) 4 also makes a decision about the ETH-CC (step S2 in FIG. 3). Then, since the received frame is a user frame, the learning process is not performed. A case where the edge switch (A) 3, the edge switch (B) 4, and the backbone switch 2 has a plurality of output ports is explained hereinafter. When each switch has a plurality of output ports and a user frame is to be transmitted in a state where the MAC address has not been learned yet, each switch transmits the user frame to the opposed apparatus through the plurality of output ports. When each switch has a plurality of output ports and a user frame is to be transmitted in a state where the MAC address has been already learned by using the ETH-CC, the output port through which the user frame is output is specified by using the MAC address learning result.

As described above, in this exemplary embodiment, when a user frame is transmitted in an un-learned state, the MAC address learning process is not performed for the user frame. Therefore, no additional load is placed on the MAC address learning function unit 14 regardless of at which rate the user frame is transmitted. For example, even when user frames are exchanged at a rate of about 10 Gbps in an interface of 10 Gbps, only a load equivalent to about 150 Kbps (when an ETH-CC is transmitted every 3.3 ms), which is the maximum rate under the ETH-CC standards, is placed.

Therefore, in the case of Ethernet™ with an interface of 10 Gbps, the load is one twenty-thousandth of the ordinary load or smaller, thus achieving a significant load reducing effect. The maximum rate of the ETC-CC is fixed. Therefore, this effect becomes larger with increase in the interface speed.

Further, in this exemplary embodiment, the frames for which MAC addresses need to be learned are reduced, thus providing another advantageous effect that the overall power consumption of the apparatuses and the network is also reduced.

Note that although only the ETH-CC frame is described in this exemplary embodiment, the present invention is not limited to the ETH-CC frame. The ETH-CC frame is one type of the E-OAM frame, and is a frame that is often used in the technical field to which the present invention belongs and that is an object with which an advantageous effect according to the present invention can be easily obtained. Therefore, the present invention may be applied to all types of E-OAM frames, or may be applied to a certain type of frames such as ETH-CC frames.

What is claimed is:

1. A switch device used in a network in which a MAC (Media Access Control) address to be used is limited within a closed network, comprising:
a determination unit that determines whether a received frame is an Ether-OAM (Operations, Administration and Maintenance) frame or not; and
a MAC address learning unit that, when the received frame is determined to be an Ether-OAM frame in the determination unit, regards that Ether-OAM frame as an object to be learned and thereby learns a MAC address.

2. The switch device according to claim 1, wherein the determination unit and the MAC address learning unit are used in an edge switch and a backbone switch forming a PBBN (Provider Backbone Bridge Network).

3. The switch device according to claim 2, wherein the edge switch transmits/receives an ETH-CC [Ethernet™ Continuity Check] bidirectionally between an inlet edge switch and an outlet edge switch within the PBBN.

4. A network in which a MAC (Media Access Control) address to be used is limited within a closed network, wherein a switch device comprising:
a determination unit that determines whether a received frame is an Ether-OAM (Operations, Administration and Maintenance) frame or not; and
a MAC address learning unit that, when the received frame is determined to be an Ether-OAM frame in the determination unit, regards that Ether-OAM frame as an object to be learned and thereby learns a MAC address.

5. The network according to claim 4, wherein the switch device is used in an edge switch and a backbone switch forming a PBBN (Provider Backbone Bridge Network).

6. The network according to claim 5, wherein the edge switch transmits/receives an ETH-CC [Ethernet™ Continuity Check] bidirectionally between an inlet edge switch and an outlet edge switch within the PBBN.

7. An address learning method used in a network in which a MAC (Media Access Control) address to be used is limited within a closed network, wherein a switch device executes:
a determination process of determining whether a received frame is an Ether-OAM (Operations, Administration and Maintenance) frame or not; and
when the received frame is determined to be an Ether-OAM frame in the determination process, a MAC address learning process of regarding that Ether-OAM frame as an object to be learned and thereby learning a MAC address.

8. The address learning method according to claim 7, wherein the switch device is used in an edge switch and a backbone switch forming a PBBN (Provider Backbone Bridge Network).

9. The address learning method according to claim 8, wherein an ETH-CC [EthernetTM™ Continuity Check] is bidirectionally transmitted/received between an inlet edge switch and an outlet edge switch within the PBBN.
